(19) United States
(12) Patent Application Publication
(10) Pub. No.: US 2006/0248925 A1
(43) Pub. Date: Nov. 9, 2006

(54) Conditioning optical fibers for improved ionizing radiation response

(76) Inventors: Paul E. Sanders, Madison, CT (US); Trevor W. MacDougall, Simsbury, CT (US); Edward M. Dowd, Madison, CT (US); Andrew S. Kuczma, Clinton, CT (US)

Correspondence Address: PATTERSON & SHERIDAN, L.L.P., 3040 POST OAK BOULEVARD, SUITE 1500, HOUSTON, TX, 77056, US

(21) Appl. No.: 11/400,096

(22) Filed: Apr. 6, 2006

Related U.S. Application Data
(60) Provisional application No. 60/668,641, filed on Apr. 6, 2005.

(51) Int. Cl. C03B 37/018; C03B 37/01; C03C 25/00

(52) U.S. Cl. 65/392; 65/424; 65/426

(57) ABSTRACT

Embodiments of the present invention provide various methods to fabricate optical fibers with reduced radiation sensitivity. Optical fibers are treated to one or more secondary or post-processing “conditioning” steps to create and anneal residual defects in the glass for improved radiation insensitivity.

### CROSS-REFERENCE TO RELATED APPLICATIONS

This application claims benefit of U.S. provisional patent application Ser. No., 60/668641, filed Apr. 6, 2005, which is incorporated herein by reference.

### BACKGROUND OF THE INVENTION

1. Field of the Invention

Embodiments of the present invention generally relate to optical fibers and, more particularly, to improving radiation response of optical fibers.

2. Description of the Related Art

Optical fibers are typically formed by heating and drawing an optical fiber preform. The preform typically includes a core and surrounding cladding, with the core and/or cladding possibly doped with appropriate materials to achieve a desired refractive index. In order to guide light through the core, the materials of the core and cladding are selected such that the refractive index of the core is at least slightly higher than the cladding.

Optical signals propagating through fibers experience induced attenuation or “darkening” when the fiber is exposed to ionizing radiation. This radiation-induced attenuation causes optical signal loss that degrades performance of optical sensor and communication systems. These radiation-induced losses are both transient and permanent in common telecommunications-grade optical fibers.

Radiation induced attenuation in silica optical fibers is typically due to the presence of glass structural defects such as non bridging oxygen centers, alkali electron centers, and lattice vacancies in the silica network. Under ionizing radiation, carriers travel to these defect sites and form light-absorbing color centers. These effects are even more prevalent in conventional fibers with refractive index modifying core dopants, such as germanium and phosphorus, as well fiber containing other glass contaminants. The more complex glass network formed with the addition of these dopants leads to a higher incidence of structural defects, such that these dopants are considered radiation-sensitizing agents.

For application in environments with high radiation, such as nuclear and hydrogen environments, pure silica core optical fibers containing no refractive index modifying dopants have been developed and proposed. Manufacturers such as Sumitomo Electric Industries in Japan offer pure silica core fibers with index lowering doped cladding glasses that show improved performance under these environments. These fibers are manufactured under ultra-pure and highly oxidizing conditions leading to glass with low levels of defects and virtually free from contaminants.

Despite this high purity processing, however, these fibers still exhibit some radiation sensitivity, albeit at low levels when compared to conventional optical fibers. Under radiation exposure, these fibers will exhibit some attenuation that typically grows linearly with radiation exposure dosage. Upon removal from the radiation environment, these fibers typically recover almost completely to their original transparency.

For typical digitally modulated communications optical systems, this slight transient attenuation and associated signal loss can be accommodated through proper link design to ensure an adequate power budget to maintain a required level of optical signal to noise ratio (OSNR). However for other types of systems, such as optical sensing systems, even slight signal power loss can lead to significant measurement errors. For example, in some intensity modulated sensors, radiation induced losses are not distinguishable from the measured signal (measurand). In some high sensitivity interferometric sensors, such as interferometric fiber optic gyroscopes (IFOGs) used in guidance systems, transient signal loss can affect the sensor scale factor and random noise performance. This becomes especially problematic for such sensors to maintain performance when operating in hostile nuclear environments.

Optical fibers that exhibit negligible sensitivity to radiation are thus desired for such applications. Accordingly, what are needed are fibers with improved radiation insensitivity and methods of making the same.

### SUMMARY OF THE INVENTION

One embodiment provides a method for fabricating a radiation hardened optical fiber. The method generally includes drawing the optical fiber from a preform, chemically treating the fiber to create defects that would cause attenuation of optical signal transmitted through the fiber, and photo-annealing the defects by launching light down the optical fiber.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates exemplary process steps for conditioning an optical fiber for improved radiation response, in accordance with one embodiment of the present invention.

### DESCRIPTION OF THE PREFERRED EMBODIMENT

Embodiments of the present invention provide various methods to fabricate optical fibers with reduced radiation sensitivity. While conventional radiation hardened fiber approaches leverage the performance realized in pure silica core fibers, embodiments described herein treat such fibers to one or more secondary or post-processing “conditioning” steps to create and anneal residual defects in the glass for improved radiation insensitivity.

Pure silica core fibers typically only exhibit transient radiation effects. These effects are believed to be due to glass structural defects present in the galsss such as oxygen vacancies, or strain effects from drawing the glass into fiber. Stress at the fiber core/cladding interface, a result of the compositional and thermo-mechanical difference of the two glasses, could cause weakened or broken bonds. These draw-induced defects have been extensively studied and correlation of draw tension and fiber radiation performance is well documented. Regardless, despite ultra-high purity and low defect glass fabrication, some defects are produced and are somewhat inherent to the fiber drawing process. In some cases, irradiating pure silica core fibers may result in recovery to almost their original transparency, suggesting that these defects may be healed (annealed) over time after radiation exposure.

According to some embodiments of the present invention, prior to such radiation exposure, optical fibers (e.g., pure silica core optical fibers) may be conditioned to an environment in which carriers travel to these as-drawn fiber defects and form color centers. These color centers may be subsequently annealed or eliminated, for example, via radiation exposure. The resulting treated fiber therefore may be virtually defect free and, thus, less sensitive to radiation exposure and exhibit no transient effects. Various conditioning environments may be utilized, for example, exposing the fiber to gamma and x-ray radiation sources, or to chemical sources, such as hydrogen and hydrogen isotopes. In any case, after such conditioning, the fiber may be thermally or optically annealed in a benign or chemical environment.

One example of conditioning, is to treat the fiber in a heated pressurized chamber, where the fiber is exposed to a chemical (e.g., hydrogen and/or deuterium). For one embodiment, the fiber may be treated in a pressurized chamber with hydrogen (e.g., 350 psi hydrogen) for several days at an elevated temperature (e.g., 10-days at 100° C.). After this treatment, the fiber may be removed and further treated, for example, by baking at 100 C for another 10-days under ambient atmospheric conditions.

As another example of conditioning, a fiber may be irradiated. For one embodiment, broadband light may be launched into a fiber exposed to steady-state radiation, such as a gamma source radiation (e.g., in a Cobalt 60 cell). As color centers are formed due to the radiation, they are photo-annealed by the broadband light illumination. Many other potential variations exist to, in effect, create defects (color centers) and subsequently fix them (anneal).

For some embodiments, ultra-violet (UV) light may be launched into a treated fiber (e.g., treated with hydrogen and/or deuterium as described above) to photo-anneal defects. However, UV light may be attenuated in fiber at a relatively high rate and, therefore, may photo-anneal only a limited length of fiber. For interferometric fiber optic gyroscope (IFOG) applications, for example, lengths of fiber in excess of 1 km may be required and UV light may only be able to photo-anneal a fraction of this length. To compensate for this attenuation, the power of the UV light may be increased. This increased power may lead to permanent attenuation in the fiber which, depending on the application, may be acceptable.

For other embodiments, however, light in the visible range may be utilized for photo-annealing. This visible light may suffer much less attenuation than UV light and may, therefore, be able to photo-anneal longer lengths of fiber than UV light.

For some embodiments, photo-annealing of defects may be performed as part of the draw process. For example, during the draw process, the preform or fiber drawn therefrom may be irradiated from the side at some point before a final coating is applied.

### An Exemplary Conditioning Recipe

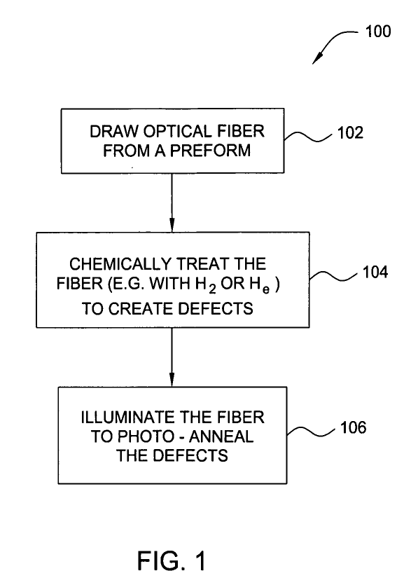

FIG. 1 is a flow diagram illustrating how a fiber may be conditioned, in accordance with one embodiment of the present invention. At step 102, the fiber is drawn. At step 104, the fiber is chemically treated (e.g., with hydrogen and/or deuterium, to create defects (color centers).

For some embodiments, a length of pure silica core single mode fiber operating at 1550 nm is first hydrogenated by exposing the fiber to hydrogen gas in a pressurized and heated chamber. For example, a spool of such fiber may be placed in the chamber and then pressurized to 350 psi with pure hydrogen gas. The chamber may then be vented to ambient pressure and then pressurized again to 350 psi. This procedure may be repeated several times to bleed off any residual atmospheric gases. The chamber may then pressurized by pure hydrogen gas to 350 psi and then heated to 75° C.

The chamber with fiber may be held in this condition for a a duration that ensures complete hydrogenation of the fiber (e.g., 48 hours). Of course, it is well understood that hydrogenation of fiber is generally dependent on time, pressure, and temperature such that higher pressure (>5,000 psi) and temperatures (>150° C.) can be used to reduce treatment time based, for example, on the ratings of the chamber, temperature limits of the fiber coatings, and the like. The chamber is then vented and the fiber removed.

At step 106, the fiber is illuminated to photo-condition (e.g., to photo-anneal or photo-bleach) the defects (color centers). For example, within an hour after the hydrogen exposure described above, 10 W of 488 nm laser light from an argon-ion laser may be launched into one end of the fiber spool to promote photo-bleaching of color centers. The fiber may be held in this launch position for 5 to 7 days, whereupon it is removed and preconditioning of the fiber is complete. For some embodiments, rather than wait until after the fiber is drawn, the photo-conditioning may occur “on the draw tower” while the fiber is being drawn.

In any case, other light sources may also be used for photo-conditioning, including, but not limited to ultra-violet and visible sources, such as arc lamps, ultra-violet lasers operating from 240 nm-325 nm, diode lasers operating at telecommunications wavelengths from 1300 nm-1600 nm where light transmission is greatest for silica fibers, as well as broadband super luminescent diodes operating at these wavelengths.

Photo-bleaching can also be accomplished by through side or lateral exposure of the fiber using these light sources as typical fiber coatings are thin and transmissive to these light sources. In addition, photo-bleaching of fiber can be accomplished on the fiber draw tower by lateral light exposure as the fiber is heated and drawn. In the draw process, protective fiber coatings are applied almost immediately as the fiber exits the draw furnace, and cured using thermal or high-intensity ultra-violet lamps. Therefore, one effective means of photo-bleaching the fiber is to position a lamp immediately at the exit of the draw furnace to expose the fiber in its pristine, uncoated state.

Table I below shows a “recipe” of parameters for performing these operations, in accordance with one particular embodiment described above.

TABLE I
EXEMPLARY CONDITIONING PARAMETERS

| HYDROGEN TREATMENT | | PHOTO ANNEALING | |
|---|---|---|---|
| H2 CONCENTRATION | 99% | WAVELENGTH | 488 nm |
| PRESSURE | 350 psi | POWER | 10 W |
| TEMPERATURE | 75° C. | TEMPERATURE | 25° C. |
| DURATION | 48 hours | DURATION | 120-170 hours |

Fibers treated according to the conditioning techniques described herein may exhibit an improvement in radiation induced attenuation (RIA) when compared with standard telecom fibers. For example, some military sensing applications will evaluate the suitability of optical fibers by exposing them to high energy pulsed radiation tests that simulate a “weapons” event. These tests typically measure the recovery rate of light transmission in the fiber after being bombarded with high dose/short duration pulses (e.g., 250 krad/100 ms). For many military applications, which will only tolerate systems being inoperable for seconds in duration, recovery of optical fibers are measured and rated at fractions of a second.

At a 1 millisecond ( 1/1000s) recovery point, conventional radiation hardened (rad-hard) fibers may exhibit attenuation in the range of hundreds of dB/km. However, fibers treated in accordance with the conditioning techniques described herein significantly improve upon this radiation-induced attenuation, for example, with attenuation in the range of 260 dB/km to 180 dB/km or better. This represents a substantial improvement over standard telecom fibers that may have RIA of 10,000 dB/km and higher at a 1 ms recovery point under these same test conditions.

### Conclusion

While the foregoing is directed to embodiments of the present invention, other and further embodiments of the invention may be devised without departing from the basic scope thereof, and the scope thereof is determined by the claims that follow.

What is claimed is:

1. A method for fabricating a radiation hardened optical fiber, comprising:
drawing the optical fiber from a preform;
chemically treating the fiber to create defects that would cause attenuation of optical signal transmitted through the fiber; and
photo-conditioning the defects by launching light down the optical fiber.

2. The method of claim 1, wherein photo-conditioning the defects comprises launching visible light down the optical fiber.

3. The method of claim 1, wherein chemically treating the fiber comprises soaking the fiber in a pressurized chamber containing hydrogen.

4. The method of claim 1, wherein photo-conditioning the defects comprises launching visible light down the fiber.

5. The method of claim 1, wherein photo-conditioning the defects comprises launching ultra-violet (UV) light down the fiber.

6. A method for fabricating a radiation hardened optical fiber, comprising:
drawing the optical fiber from a preform;
chemically treating at least one of the fiber and the preform to create defects that would cause attenuation of optical signal transmitted through the fiber; and
photo-conditioning the defects by at least one of: launching light down the optical fiber and exposing the preform or optical fiber drawn therefrom to light.

7. The method of claim 6, wherein photo-conditioning the defects comprises exposing the preform or optical fiber drawn therefrom to light during the drawing.

8. The method of claim 7, wherein photo-conditioning the defects comprises exposing the preform or optical fiber drawn therefrom to visible light during the drawing.

9. The method of claim 7, wherein photo-conditioning the defects comprises exposing the preform or optical fiber drawn therefrom to ultra-violet light during the drawing.

10. The method of claim 6, wherein chemically treating the fiber comprises soaking the fiber in a pressurized chamber containing hydrogen.
